(19) United States
(12) Patent Application Publication
(10) Pub. No.: US 2025/0353450 A1
(43) Pub. Date: Nov. 20, 2025

(54) VIBRATION DAMPING MEMBER, ROOF LINER, VEHICLE STRUCTURE, CEILING STRUCTURE, AND VIBRATION DAMPING STRUCTURE

(71) Applicant: INOAC CORPORATION, Nagoya-shi, Aichi-ken (JP)

(72) Inventors: Kazuya SASAZAWA, Hadano-shi (JP); Kentaro KAMIYA, Okazaki-shi (JP); Hiroki SUGIMOTO, Toyota-shi (JP); Katsuhiro TANGE, Inazawa-shi (JP)

(73) Assignee: INOAC CORPORATION, Nagoya-shi, Aichi-ken (JP)

(21) Appl. No.: 18/871,264

(22) PCT Filed: Jun. 6, 2023
(86) PCT No.: PCT/JP2023/021071

§ 371 Date: Dec. 3, 2024

(30) Foreign Application Priority Data
Jun. 26, 2022 (JP) 2022-102298

(51) Int. Cl. B60R 13/02; B32B 3/30; B32B 5/18

(52) U.S. Cl. CPC B60R 13/0212; B32B 3/30; B32B 5/18; B32B 2250/03; B32B 2307/51; B32B 2307/56; B32B 2307/72; B32B 2605/00

(57) ABSTRACT

A vibration damping member includes a foam having a first outer surface on which a plurality of protrusions are arranged and having an average elastic modulus in a compressive strain range of 0 to 30% being from 3 kPa to 27 kPa, inclusive.

### TECHNICAL FIELD

The present disclosure relates to a vibration damping member.

### BACKGROUND ART

Various techniques for suppressing vibration have been proposed (see, for example, Patent Document 1).

### RELATED ART DOCUMENTS

### Patent Documents

Patent Document 1: JP H10-203267 A (paragraph [0010], etc.)

### SUMMARY OF THE INVENTION

### Problems to be Solved by the Invention

A need exists for a novel vibration damping technique.

### Means of Solving the Problems

A first aspect of the invention is a vibration damping member including: a foam having a first outer surface on which a plurality of protrusions are arranged and having an average elastic modulus in a compressive strain range of 0 to 30% being from 3 kPa to 27 kPa, inclusive.

### BRIEF DESCRIPTION OF THE DRAWINGS

FIG. 1A is a perspective view of a vibration damping member mounted to a vehicle, and FIG. 1B is a cross-sectional rear view of a roof liner including the vibration damping member,

FIG. 2 is a cross-sectional side view of a ceiling structure.

FIG. 3 is an exploded perspective view of the ceiling structure of the vehicle.

FIG. 4 is a perspective view of the vibration damping member,

FIG. 5 is a plan photograph of the vibration damping member.

FIG. 6A is a cross-sectional view of the vibration damping member taken along line A-A, and FIG. 6B is a cross-sectional view of the vibration damping member taken along line B-B.

FIG. 7A is a cross-sectional view of the vibration damping member taken along line C-C, and FIG. 7B is a cross-sectional view of the vibration damping member taken along line D-D.

FIG. 8 is a side view of a processing line for feeding a sheet to be profiled.

FIG. 9 is a side view of the processing line while the sheet is being profiled.

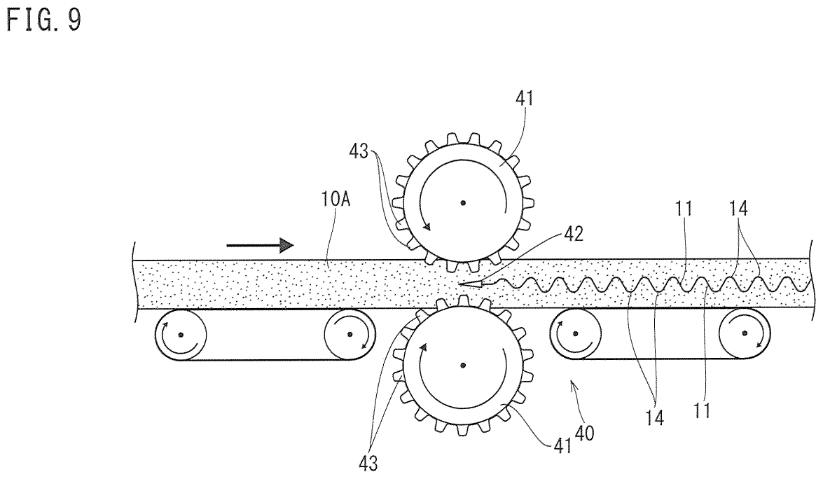

FIG. 10 is a cross-sectional view of a test instrument for a vibration damping property test,

FIG. 11 is a cross-sectional view of a vibration damping member and a roof liner in the vibration damping property test.

FIG. 12A is a table showing the properties of vibration damping members of Examples and Comparative Examples, and FIG. 12B is a graph showing stress-strain curves of vibration damping members of Example 1 and Comparative Examples 1 and 2.

FIG. 13 is a graph showing stress-strain curves up to a compressive strain of 30% of the vibration damping members of Examples and Comparative Examples.

FIG. 14A is a graph showing a resonance frequency and a vibration transmissibility in Examples and Comparative Examples, and FIG. 14B is a graph showing a resonance frequency and a vibration transmissibility in Examples and Comparative Examples using a vibration damping member of a polyurethane resin foam.

FIG. 15A is a cross-sectional view of a vibration damping member, a steel plate, and a sound insulation layer in a transmission loss test, and FIG. 15B is a graph showing a transmission loss in Example 1 and Comparative Examples 4 and 5,

### MODE FOR CARRYING OUT THE INVENTION

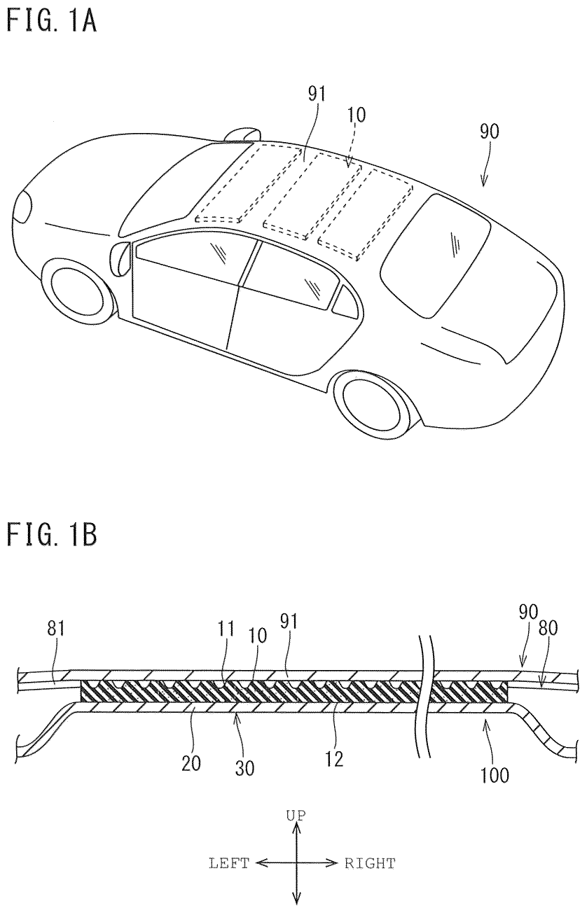

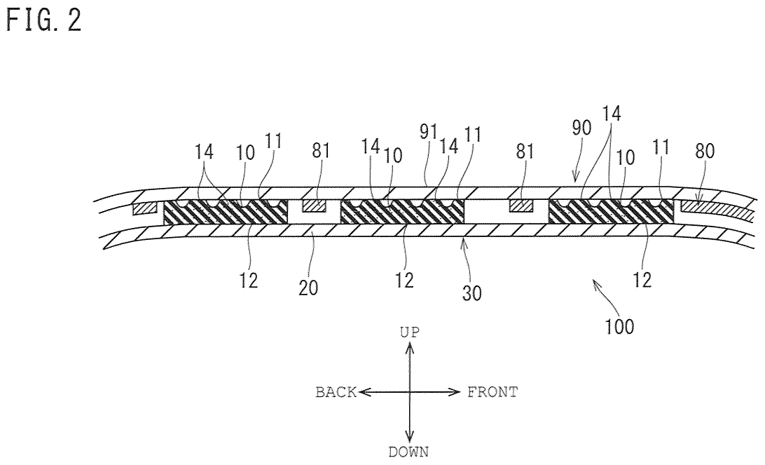

A vibration damping member 10 according to an embodiment of the present disclosure is brought into contact with another member to reduce vibration of the member, and is formed of a foam. FIG. 1A illustrates a usage example of the vibration damping member 10. In this example, the vibration damping member 10 is provided in a ceiling structure 100 of a vehicle 90 (see FIGS. 1B and 2). The ceiling structure 100 is provided with a roof panel 91 as a vehicle body panel, and a roof liner 20 that is an interior member of a ceiling and is stacked on the roof panel 91 from below. In the ceiling structure 100, the vibration damping member 10 is sandwiched between the roof panel 91 and the roof liner 20 to damp vibration of the roof panel 91.

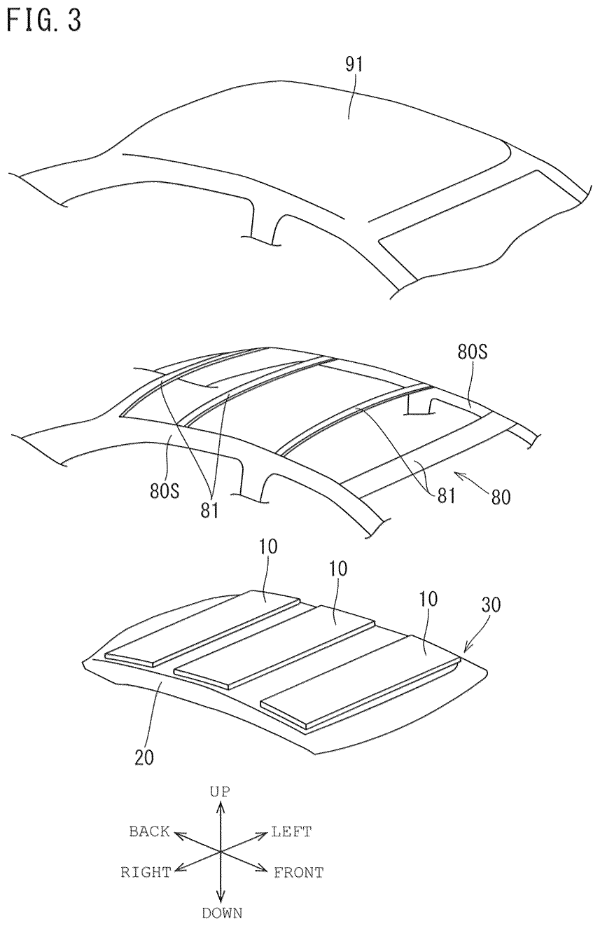

As illustrated in FIGS. 2 and 3, a reinforcement 80 may be provided between the roof panel 91 and the roof liner 20. In this case, for example, the vibration damping member 10 is disposed at a position avoiding the reinforcement 80. In the example of the present embodiment, the vibration damping member 10 has a sheet shape, and extends in the vehicle width direction (left-right direction). A plurality of the vibration damping members 10 are placed on the roof liner 20 in the front-back direction (see FIGS. 1A and 2).

The reinforcement 80 is fixed in contact with the roof panel 91 (see FIG. 2) to reinforce the roof panel 91. For example, as illustrated in FIG. 3, the reinforcement 80 is provided with a pair of side rail reinforcements 80S to be stacked on a side portion of the roof panel 91, and lateral beams 81 extending in the vehicle width direction and bridged between the side rail reinforcements 80S. The lateral beams 81 are brought into contact with a lower surface of the roof panel 91 (see FIG. 2). In the example of the present embodiment, the vibration damping member 10 is disposed between the pair of side rail reinforcements 80S in the vehicle width direction, and is disposed between the lateral beams 81 in the front-back direction.

For example, members such as an assist grip, a rear-view mirror, and an interior light to be attached to the roof panel 91 pass through the roof liner 20, and the roof liner 20 is fixed to the vehicle body panel by these members. In this case, for example, the vibration damping member 10 is disposed at a position avoiding these members as well.

As illustrated in FIG. 3, for example, a side edge portion of the roof panel 91 is supported by a pillar of the vehicle 90. In such a configuration, it is considered that a central portion in the vehicle width direction of the roof panel 91 is more likely to vibrate than the side edge portion. Therefore, it is preferable that the vibration damping member 10 is in contact with at least the central portion in the vehicle width direction of the roof panel 91.

The vibration damping member 10 may be fixed (for example, bonded) to an upper surface of the roof liner 20. The vibration damping member 10 may be fixed to the roof liner 20 during an attachment process to the vehicle 90, or a vibration damping member-equipped roof liner 30 (see FIG. 3) in which the vibration damping member 10 has been fixed to the upper surface of the roof liner 20 may be formed in advance.

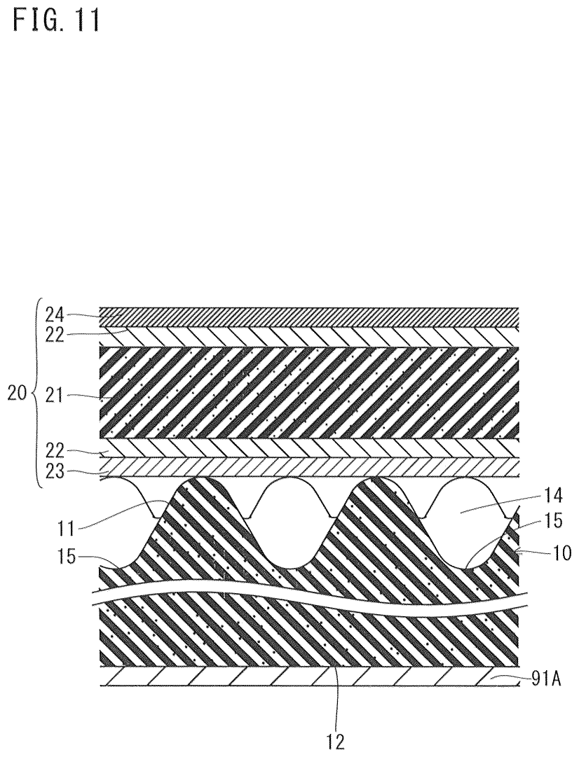

In the present embodiment, for example, the roof liner 20 is formed by molding (for example, heat press molding) a laminated sheet in which a plurality of sheets are laminated into a shape along the roof panel 91. For example, as illustrated in FIG. 11, the laminated sheet may have a configuration in which a foam sheet 21 is sandwiched between a pair of fiber sheets 22 (for example, glass fiber sheets), and these sheets are further sandwiched between a pair of surface members 23 and 24 from the outside. In this configuration, for example, the surface members 23 and 24 are formed of a resin sheet, a nonwoven fabric, or the like.

In the example of the present embodiment, the foam constituting the vibration damping member 10 has air permeability and has an open-cell structure or a semi-open-cell structure. Since the vibration damping member 10 is formed of the foam having air permeability, the vibration damping member 10 can be sound-absorbent. A cell membrane (so-called mirror) between foam cells of the foam can be removed by, for example, a blast of combustion gas or hydrolysis with alkali, but is desirably left without being removed. The presence of the cell membrane makes it possible to improve the vibration damping property of the foam as compared with a case with no cell membrane. The foam constituting the vibration damping member 10 may be air-impermeable or may have a closed-cell structure.

In the present embodiment, the foam constituting the vibration damping member 10 is a foam of a polyurethane resin, but is not limited thereto, and may be, for example, a foam of a polyolefin resin such as a polyethylene resin or a polypropylene resin, or a foam of a phenol resin. In the example of the present embodiment, the vibration damping member 10 is formed of slab urethane and is cut into a sheet shape, for example.

It is preferable that the vibration damping member 10 has an apparent density of 40 kg/m³ or less from the viewpoint of weight reduction, for example. The weight of the vibration damping member 10 is reduced as above. Thus, for example, in a case where the vibration damping member 10 is mounted on a vehicle such as the vehicle 90, it is possible to improve the fuel efficiency and electricity efficiency of the vehicle.

As described above, the vibration damping member 10 of the present embodiment includes the foam, and is brought into contact with a vibrating member by, for example, being sandwiched between two members (see FIGS. 1B and 2), to be able to damp the vibration of the member. Here, an interval between the vehicle body panel such as the roof panel 91 and the interior member such as the roof liner 20 is generally not uniform due to the shapes of the vehicle body panel and the interior member, variations in molding, and the like. Therefore, for example, in a place where the interval is narrow, a problem occurs in which the vibration damping member 10 is strongly pressed, and a resilient force of the vibration damping member 10 becomes too strong. As a result, in the example of the present embodiment, for example, when the roof liner 20 is attached to the roof panel 91, the roof liner 20 may be pushed back downward by the resilient force of the vibration damping member 10 (so-called attachment load is large), and it may become difficult to fix the roof liner 20 by the members such as an assist grip, a rear-view mirror, and an interior light.

To address the problem, in the vibration damping member 10 of the present embodiment, the surface to be brought into contact with another member is an uneven surface on which a plurality of protrusions 14 are arranged. As a result, the resilient force of the vibration damping member 10 sandwiched between the members can be inhibited from becoming too strong (compressive load can be inhibited from becoming too high) as compared with a vibration damping member having a uniform thickness. Specifically, in the vibration damping member 10 of the present embodiment, a first surface 11 as one of front and rear surfaces is the uneven surface. In the present embodiment, a second surface 12 on the side opposite to the first surface 11 out of the front and rear surfaces of the vibration damping member 10 is a flat surface.

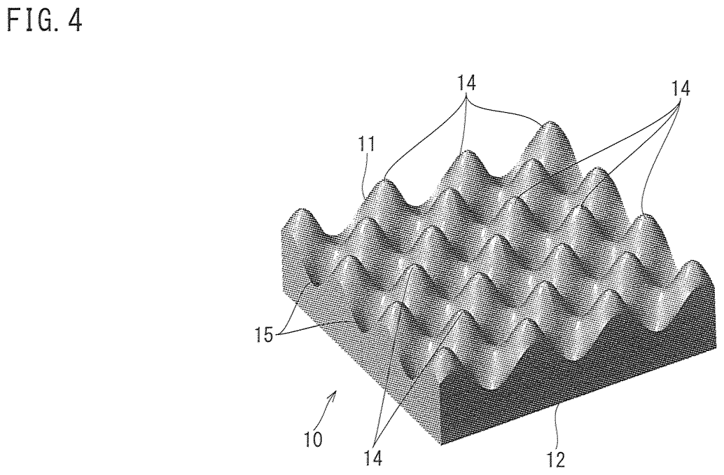

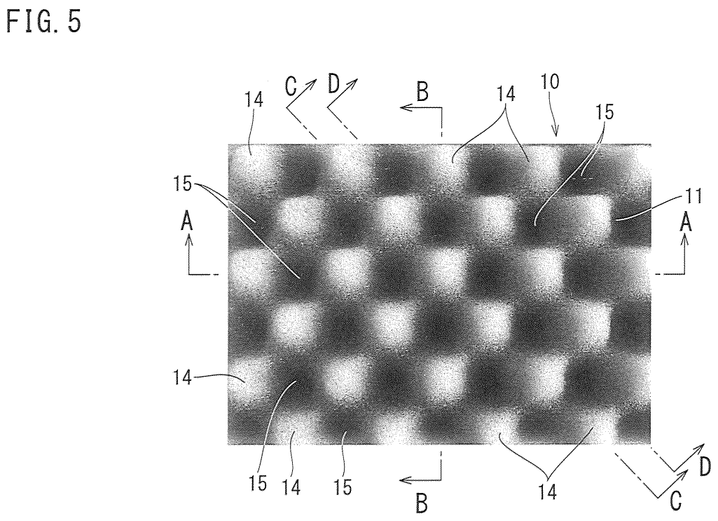

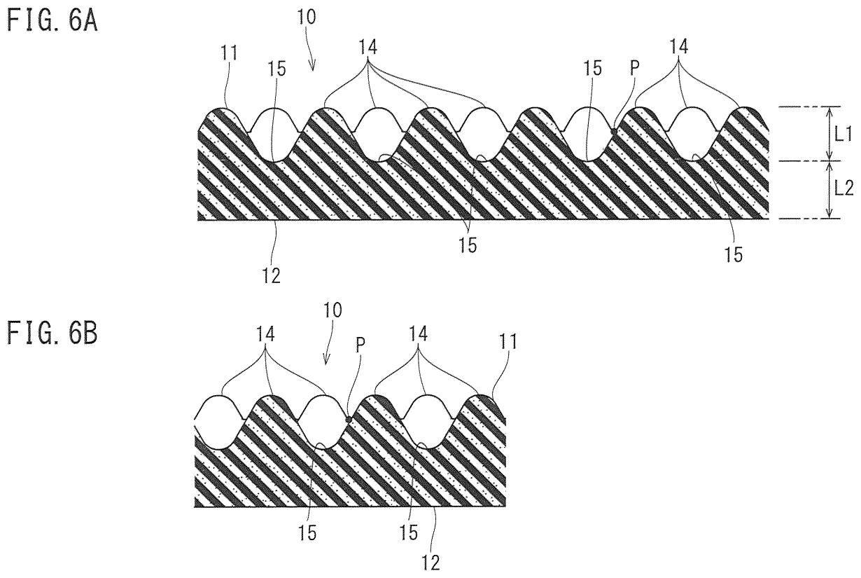

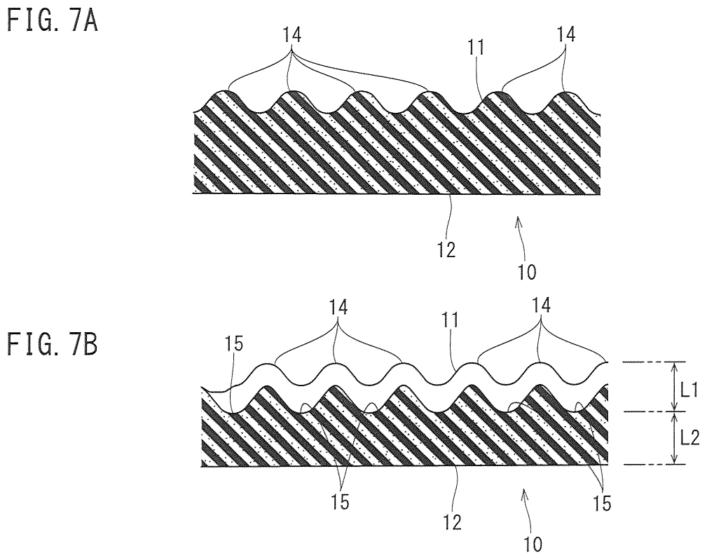

As illustrated in FIG. 4, in the example of the present embodiment, a large number of protrusions 14 are two-dimensionally arranged over the entire first surface 11. For example, an uneven pattern including the plurality of protrusions 14 is two-dimensionally repeated in a given pattern on the first surface 11, and the plurality of protrusions 14 are arranged in a lattice pattern at regular intervals (see FIG. 5). In the example of the present embodiment, the plurality of protrusions 14 are in a staggered arrangement. For example, the vibration damping member 10 has a rectangular sheet shape in plan view. A line of the plurality of protrusions 14 arranged at a constant pitch in the longitudinal direction of the vibration damping member 10 is disposed so as to be shifted in the longitudinal direction by a half pitch with respect to another line of the plurality of protrusions 14 that is adjacent to that line in the lateral direction of the vibration damping member 10 (see FIGS. 5 and 6). In addition, in the longitudinal direction and the lateral direction of the vibration damping member 10, a valley bottom portion 15 closest to the second surface 12 in the first surface 11 is provided between the protrusions 14 (see FIGS. 6A and 6B). For example, a top portion of the protrusion 14 and the valley bottom portion 15 are repeated at regular intervals, and the valley bottom portions 15 are also in a staggered arrangement. In addition, in the example of the present embodiment, the uneven pattern of the first surface 11 is symmetrical in the longitudinal direction and the lateral direction of the vibration damping member 10. FIG. 6A is a cross-sectional view of the vibration damping member 10 in a cross section (A-A cross section) passing through the top portions of the protrusions 14 and the valley bottom portions 15 that are alternately arranged in the longitudinal direction. FIG. 6B is a cross-sectional view of the vibration damping member 10 in a cross section (B-B cross section) passing through the top portions of the protrusions 14 and the valley bottom portions 15 that are alternately arranged in the lateral direction. FIG. 7A is a cross-sectional view of the vibration damping member 10 in a cross section (C-C cross section) passing through the top portions of the protrusions 14 that are arranged in a direction inclined with respect to the longitudinal direction and the lateral direction (for example, a direction inclined by 45 degrees). FIG. 7B is a cross-sectional view of the vibration damping member 10 in a cross section (D-D cross section) passing through the valley bottom portions 15 arranged in the above-described inclined direction. In the example of the present embodiment, the protrusions 14 have the same shape and size.

In the example of the present embodiment, the protrusions 14 have a shape (for example, a chevron shape) in which the cross-sectional area decreases toward their protruding tip, and the first surface 11 is a curved surface having a wave shape in cross-sectional view as illustrated in FIGS. 6 and 7. The protrusions 14 have a shape in which the gradient gradually increases toward the protruding tip from their proximal end side up to an intermediate position P and the gradient gradually decreases from the intermediate position P to the protruding tip (that is, the intermediate position P is an inflection point). The protruding tips of the protrusions 14 are rounded. For example, the valley bottom portions 15 are disposed substantially at the center in the thickness direction of the vibration damping member 10 (that is, as illustrated in FIGS. 6 and 7, a distance L1 from the protruding tips of the protrusions 14 to the valley bottom portions 15 is substantially the same as a distance 12 from the valley bottom portions 15 to the second surface 12).

In the present embodiment, the first surface 11 of the vibration damping member 10 (that is, the plurality of protrusions 14) is brought into contact with the roof panel 91 (that is, the first surface 11 is directed upward). In the vibration damping member 10 of the present embodiment, in a case where the vibration damping member 10 is pressed against the roof panel 91 (particularly when compressed by less than the protruding height of the protrusions 14, or the like), it is possible to inhibit the resilient force of the vibration damping member 10 at the time of compression from becoming too strong as compared with a vibration damping member having a uniform thickness. In addition, since the protrusions 14 have a shape in which the cross-sectional area decreases toward the protruding tip, the resilient force of the vibration damping member 10 can be further reduced when the amount of compression of the protrusions 14 is small, which makes it possible to more easily fix the vibration damping member 10.

In addition, in the example of the present embodiment, the first surface 11 is a profiled surface formed by profiling. Therefore, the uneven pattern on the first surface 11 can be easily formed.

By the way, it is desirable to further improve the vibration damping property of the vibration damping member including the foam. Therefore, the inventors of the present application have investigated a relationship between the vibration damping property and the properties of the foam. As a result of intensive studies, the inventors have obtained knowledge about a configuration capable of further improving the vibration damping property by focusing on the elastic modulus of the foam, and have invented the vibration damping member 10 of the present disclosure.

Specifically, in the vibration damping member 10, an average elastic modulus in the compressive strain range of 0 to 30% (the compressive strain ranges from 0 to 0.3, inclusive) is from 3 kPa to 27 kPa, inclusive. This makes it possible to remarkably improve the vibration damping property as described later. Here, the average elastic modulus in the compressive strain range of 0 to 30% is obtained as the slope of an approximate straight line in the range in which a strain is from 0% to 30%, inclusive, with respect to a stress-strain curve when the vibration damping member 10 is compressively deformed. The approximate straight line and the slope thereof are calculated by a least squares method and can be obtained, for example, by spreadsheet software “Microsoft Excel” (manufactured by Microsoft Corporation).

For example, the vibration damping member 10 may be used by being sandwiched between two members such as the roof panel 91 and the roof liner 20 so as to fall within the range of a predetermined compressive strain. For example, as this range, a range in which the uneven pattern of the first surface 11 is not completely collapsed (in the example of the present embodiment, 0% or more and less than 50%) may be adopted. Furthermore, as this range, a range from a compressive strain of 0% to a compressive strain equal to or less than a proportional limit (for example, the compressive strain range of 0 to 30%) in the stress-strain curve may be adopted. As the range of the compressive strain equal to or less than the proportional limit, for example, a range in which a determination coefficient R2 (the square of a correlation coefficient) in the approximate straight line of the stress-strain curve is 0.95 or more may be adopted.

As described above, in the example of the present embodiment, the vibration damping member 10 is disposed so that the first surface 11 is directed upward, and the first surface 11 is brought into contact with the roof panel 91 (see FIGS. 1B and 2), By bringing the first surface 11 having the plurality of protrusions 14 into contact with the roof panel 91 in this manner, the vibration damping member 10 can be easily compressed correspondingly to the shape of the lower surface of the roof panel 91 (can be easily adapted to the shape of the lower surface of the roof panel 91). For example, the roof panel 91 may be provided with a bead-processed portion that extends in the front-back direction for the purpose of increasing strength or the like. The bead-processed portion forms a protrusion or a recess on the lower surface of the roof panel 91, so that the lower surface of the roof panel 91 is formed in an uneven shape. Even for such a configuration, the vibration damping member 10 of the present embodiment can be easily adapted to the shape of the lower surface of the roof panel 91. In the example of the present embodiment, the surface of the vibration damping member 10 to be brought into contact with the vehicle body panel (the roof panel 91) is the first surface 11, but may be the second surface 12.

In the roof liner 20, the vibration damping member 10 may be fixed to the upper surface. In this manner, the roof liner can be provided with a function to reduce the vibration of the roof panel 91. In addition, with this configuration, the vibration damping member 10 is mounted to the vehicle 90 simply by mounting the roof liner 20 to the vehicle 90, which makes it possible to easily mount the vibration damping member 10.

In the ceiling structure 100 of the present embodiment, for example, the vibration damping member 10 extends in the vehicle width direction, and the plurality of vibration damping members 10 are placed on the roof liner 20 in the front-back direction, and are in contact with at least the central portion of the roof panel 91 in the vehicle width direction. The plurality of vibration damping members 10 are separately provided as above. Thus, in a case where the interval between the roof panel 91 and the roof liner 20 varies depending on location, the vibration damping member 10 having a thickness corresponding to the interval can be disposed, and the contact portion between the lower surface of the roof panel 91 and the vibration damping member 10 can be widened. In a case where the plurality of vibration damping members 10 are provided in this manner, the first surface 11 may be brought into contact with the roof panel 91 in some of the vibration damping members 10, and the first surface 11 may be brought into contact with the roof liner 20 in the remaining vibration damping members 10. In addition, in the configuration in which the side edge portion of the roof panel 91 is supported by the pillar as described above, it is considered that the central portion in the vehicle width direction of the roof panel 91 easily vibrates, To address this problem, the vibration damping member 10 of the present embodiment is in contact with at least the central portion of the roof panel 91 in the vehicle width direction, which makes it possible to easily damp the vibration of the central portion. The configuration may also be adopted in which the vibration damping member 10 is not in contact with the central portion of the roof panel in the vehicle width direction.

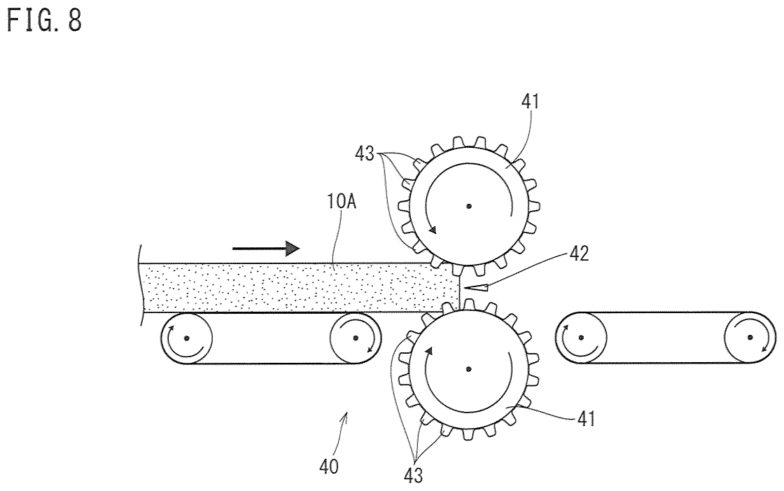

The vibration damping member 10 in which the first surface 11 is a profiled surface can be manufactured, for example, as follows. As illustrated in FIG. 8, a sheet 10A of slab urethane is fed between a pair of rollers 41 of a processing line 40. The sheet 10A is fed while being sandwiched between the pair of rollers 41 and elastically compressed, and is sliced by a cutter 42 between the pair of rollers 41. Here, the pair of rollers 41 has a plurality of outer peripheral protrusions 43 arranged at predetermined intervals on their outer peripheral surfaces, and the outer peripheral protrusions 43 are disposed to face each other in a staggered manner. Therefore, a portion of the sheet 10A into which the outer peripheral protrusions 43 of one of the rollers 41 sink from one of front and rear surfaces of the sheet 10A that has been placed between the pair of rollers 41 corresponds to a portion which the outer peripheral protrusions 43 of the other roller 41 do not butt against from the other of the front and rear surfaces and do not sink into the sheet 10A. Accordingly, the sheet 10A is elastically compressed asymmetrically in the thickness direction. Therefore, when the sheet 10A comes out to the downstream side in the feeding direction from the state of being sandwiched between the pair of rollers 41 to be elastically restored so that both the front and rear surfaces of the sheet 10A become flat, the sliced surface of the sheet 10A changes from a flat surface to an uneven curved surface, and the first surface 11 is formed. In this manner, two of the vibration damping members 10 are obtained. The sheet 10A is cut into a predetermined plane size before or after slicing.

As described above, by forming the first surface 11 by profiling, the two vibration damping members 10 can be formed at a time, which makes it possible to easily form the vibration damping member 10. In the configuration in which the valley bottom portions 15 are disposed substantially at the center in the thickness direction of the vibration damping member 10, the thickness of the sheet 10A before the profiling is substantially 1.5 times that of the vibration damping member 10.

### OTHER EMBODIMENTS

In the above embodiment, the vibration damping member 10 is provided in the ceiling structure 100 of the vehicle 90, but is not limited thereto, and can be used in a vehicle structure in which the vibration damping member 10 is sandwiched between a vehicle body panel and an interior member and the first surface 11 is brought into contact with at least one of the vehicle body panel or the interior member. In addition, the vibration damping member 10 is not limited to the one provided in the vehicle structure, and may be provided in a vibration damping structure in which the first surface 11 is brought into contact with a vibrating member. For example, the vibration damping member 10 may be used in a vibration damping structure in which the vibration damping member 10 is sandwiched between members and the first surface 11 is brought into contact with at least one of the members.

The vibration damping member 10 may be disposed in a vehicle other than an automobile, or may be disposed in a building, for example. For example, a vibration damping structure may be provided in which the vibration damping member 10 is sandwiched between two members, and the vibration damping member 10 may damp the vibration of at least one of the two members that is in contact with the vibration damping member 10 (for example, the uneven surface including the plurality of protrusions 14).

The shape of the uneven surface of the vibration damping member 10 including the protrusions 14 is not limited to the above embodiment, and the protrusions 14 may have a hemispherical shape, a conical shape such as a circular cone or a pyramid, a frustum shape such as a truncated cone or a truncated pyramid, or a columnar shape such as a circular column or prismatic columns. In addition, the protrusion 14 may be, for example, a ridge extending in the longitudinal direction or the lateral direction of the vibration damping member 10, and the first surface 11 may be an uneven surface on which a plurality of the ridges are arranged substantially in parallel. Such a ridge may have a triangular or semicircular shape in cross section.

In the above embodiment, all of the plurality of protrusions 14 have the same shape, but some of the plurality of protrusions 14 may have a shape different from that of the remaining protrusions 14. In addition, the shape and arrangement of the plurality of protrusions 14 may be random.

In the above embodiment, the second surface 12 may also be an uneven surface including the plurality of protrusions 14.

The vibration damping member 10 may have a laminated structure. For example, the vibration damping member 10 may have a laminated structure in which another sheet is laminated on the second surface 12 (for example, the flat surface) of the foam of the above embodiment.

The uneven surface including the plurality of protrusions 14 of the vibration damping member 10 may be an uneven surface (laser processed surface) obtained by laser processing instead of the profiled surface. In addition, the foam of the vibration damping material 10 may be a molded article in which the uneven surface including the plurality of protrusions 14 is formed by foaming in a mold, or may be a press-molded article in which the uneven surface is formed by press-molding a foam sheet.

In the above embodiment, the vibration damping member 10 has a sheet shape, but may have a block shape such as a rectangular parallelepiped. In this case, at least one surface of the vibration damping member 10 only needs to include an uneven surface (for example, a surface on which the plurality of protrusions 14 are formed, or the like). In this case, for example, by bringing that surface into contact with a vibrating member, the vibration of the member can be suppressed.

### EXAMPLES

Hereinafter, the above-described embodiments will be described more specifically with reference to Examples and Comparative Examples, but the vibration damping member of the present disclosure is not limited to Examples described below.

### 1. Configurations of Vibration Damping Members of Examples and Comparative Examples

As vibration damping members of Examples 1 to 6 illustrated in FIG. 6A and Comparative Examples 1 to 4, sheet-shaped vibration damping members were prepared. The vibration damping members are made of different materials.

### Examples 1 to 6

The vibration damping members 10 of Examples 1 to 6 are polyurethane resin foams and are slab urethane. In the vibration damping members 10 of Examples 1 to 6, the first surface 11 is a profiled surface having the shape illustrated in FIGS. 4 to 7, and the second surface 12 is a flat surface. In addition, the valley bottom portions 15 (see FIG. 6) are located at the center of the thickness (30 mm) of each vibration damping member 10 (that is, the distance L1 and the distance L2 are the same). A pitch between the top portions of the protrusions 14 (a pitch between the valley bottom portions 15) in the longitudinal direction and the lateral direction of the vibration damping member 10 is 31 mm.

### Comparative Example 1

The vibration damping member of Comparative Example 1 is a felt of polyethylene terephthalate resin fibers.

### Comparative Example 2

The vibration damping member of Comparative Example 2 is Thinsulate TF2300 (manufactured by 3M Company).

### Comparative Example 3

The vibration damping member of Comparative Example 3 is a polyurethane resin foam and is slab urethane. As will be described later, in the vibration damping member of Comparative Example 3, the average elastic modulus in the compressive strain range of 0 to 30% is higher than those of the vibration damping members of Examples 1 to 6.

### Comparative Example 4

In the vibration damping member of Comparative Example 4, the first surface 11 is a flat surface (that is, both the front and rear surfaces are flat surfaces). Other configurations are the same as those of the vibration damping member 10 of Example 1.

### Comparative Example 5

Comparative Example 5 is blank with no vibration damping member.

### 2. Evaluation

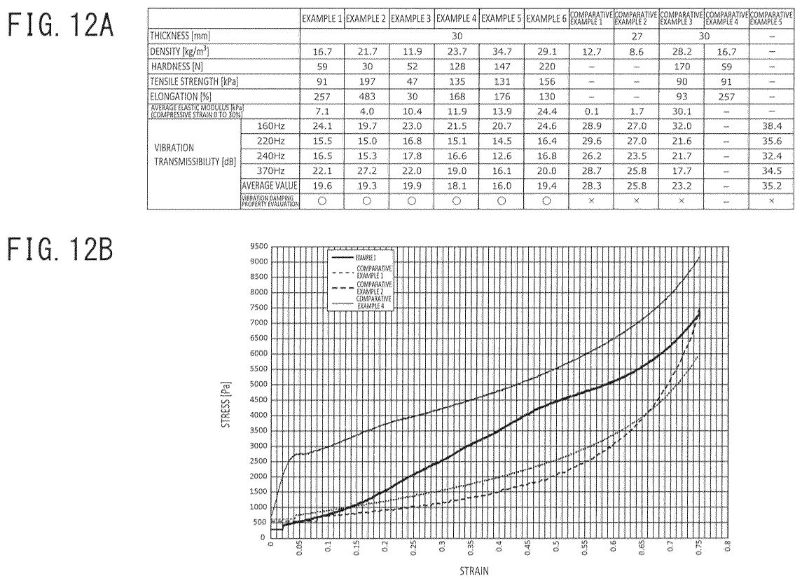

Properties such as the vibration damping properties in Examples and Comparative Examples were evaluated (see FIG. 12A). A method of measuring the respective properties of Examples and Comparative Examples is as follows.

### <Measurement Method>

### (1) Apparent Density

The density of each vibration damping member was measured in accordance with JIS K7222.

### (2) Hardness

The hardness of each vibration damping member was measured in accordance with JIS K6400-2 D method.

### (3) Average Elastic Modulus

The vibration damping members of Examples 1 to 6 and Comparative Examples 1 to 3 were compressed at 23° C. using AUTOGRAPH AG-X/R (manufactured by Shimadzu Corporation), and the average elastic modulus in the compressive strain range of 0 to 30% was obtained. The vibration damping members have a size of 100 mm×100 mm×30 mm (thickness). A pressurizer having a diameter of 200 mm was brought into contact with one of the entire front and rear surfaces of each vibration damping member (the entire first surface 11 in Examples 1 to 6), and the vibration damping member was compressed at a speed of 50 mm/min up to a compressive strain of 75% (until the thickness reached 25% of the original thickness) to obtain a stress-strain curve. Furthermore, an approximate straight line in the compressive strain range of 0% to 30%, inclusive, with respect to the stress-strain curve was obtained using spreadsheet software “Microsoft Excel” (manufactured by Microsoft Corporation), and the slope of the approximate straight line was calculated (the y intercept was not fixed). Stress data of the above stress-strain curve was plotted every 0.01 seconds from the start of pressurization up to a strain of 30%.

### (4) Vibration Damping Property

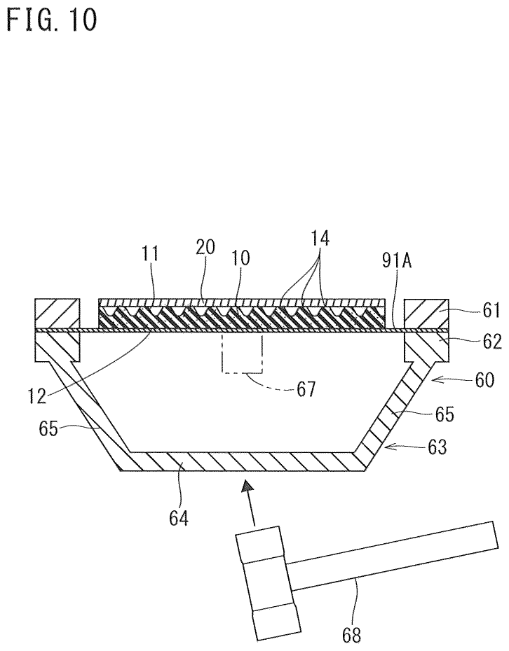

The vibration damping properties of Examples and Comparative Examples were compared. A test instrument for evaluating the vibration damping property is shown in FIG. 10. This test instrument evaluates the vibration damping property by the vibration damping member 10 by fixing the vibration damping member 10 on a steel plate 91A as the roof panel 91 and applying vibration to the steel plate 91A. Specifically, this test instrument includes a frame portion 60 for fixing an outer edge portion of the steel plate 91A. The frame portion 60 includes an upper frame 61 and a lower frame 62 screwed together while sandwiching the outer edge portion of the steel plate 91A from above and below, and includes a base portion 63 that supports the lower frame 62 from below. In the base portion 63, a side wall portion 65 is erected upward from an outer edge portion of a plate-shaped bottom portion 64, and the lower frame 62 is fixed to an upper end of the side wall portion 65 (for example, the upper end is formed integrally with the lower frame 62). In addition, the frame portion 60 is supported at four corners by a spring suspended from a support portion (not illustrated). An acceleration sensor 67 is attached to a central portion of a lower surface of the steel plate 91A. The frequency of vibration of the spring is much lower than the frequency of a resonance peak to be described later.

The vibration damping member of each of Examples and Comparative Examples (FIG. 10 illustrates the vibration damping members 10 of Examples 1 to 6) is placed on the steel plate 91A, and the roof liner 20 is further placed thereon. In Examples 1 to 6, the first surface 11 is disposed to be directed upward (that is, directed toward the roof liner 20). The plane size of the vibration damping member is 500 mm×400 mm. The steel plate 91A has a size of 600 mm×500 mm×0.8 mm (thickness), and the roof liner 20 has a size of 500 mm×400 mm×6.5 mm (thickness) and a basis weight of 580 g/m². The steel plate 91A, the vibration damping member, and the roof liner 20 are disposed so as to have the same longitudinal direction.

The roof liner 20 is formed of a laminated sheet, and as illustrated in FIG. 11, has a configuration in which the foam sheet 21 is sandwiched between the pair of glass fiber sheets, and these sheets are further sandwiched between the pair of surface members 23 and 24 from the outside. These sheets are laminated and integrated by heat press molding, and bonded by a thermosetting binder. In this test, the stacking order of the steel plate 91A (roof panel), the vibration damping member, and the roof liner 20 is upside down from that provided in the vehicle 90. That is, the one surface member 24 disposed on the uppermost side in this test is disposed on the lowermost side (vehicle interior side) when the roof liner 20 is disposed in the vehicle.

Then, in a state where the steel plate 91A is fixed to the frame portion 60 as described above, a central portion of the bottom portion 64 of the base portion 63 is hit from below with an impulse hammer 68 to apply vibration to the steel plate 91A through the frame portion 60. The vibration of the frame portion 60 when the bottom portion 64 is hit with the impulse hammer 68 is negligible compared to the vibration of the steel plate 91A.

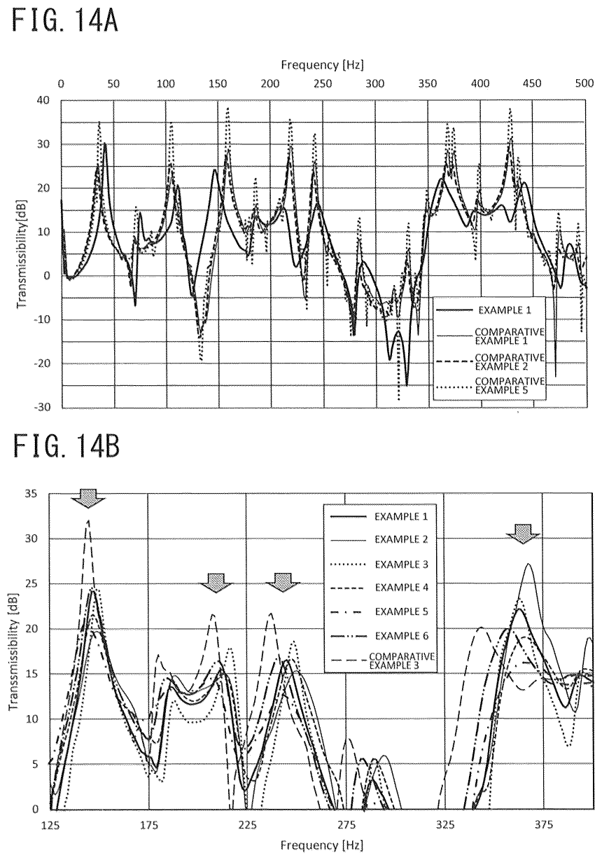

The impulse hammer 68 and the acceleration sensor 67 are connected to an FFT analyzer. Then, a vibration transmissibility [dB] for each frequency was obtained from the vibration application force of the impulse hammer 68 and the detection result of the acceleration sensor 67 (see FIGS. 14A and 14B), and the vibration transmissibility (the height of a resonance peak) was evaluated with respect to four resonance peaks (about 160 Hz, about 220 Hz, about 240 Hz, and about 370 Hz; the peaks indicated by arrows in FIG. 14B) observed around 125 to 400 Hz that are considered to particularly greatly contribute to road noise among the obtained resonance peaks.

The vibration damping property was evaluated as “o” when the average value of the vibration transmissibility at the four peaks was 22 dB or less, and as “x” when the average value exceeded 22 dB. The lower the vibration transmissibility, the better the vibration damping property.

### (5) Transmission Loss

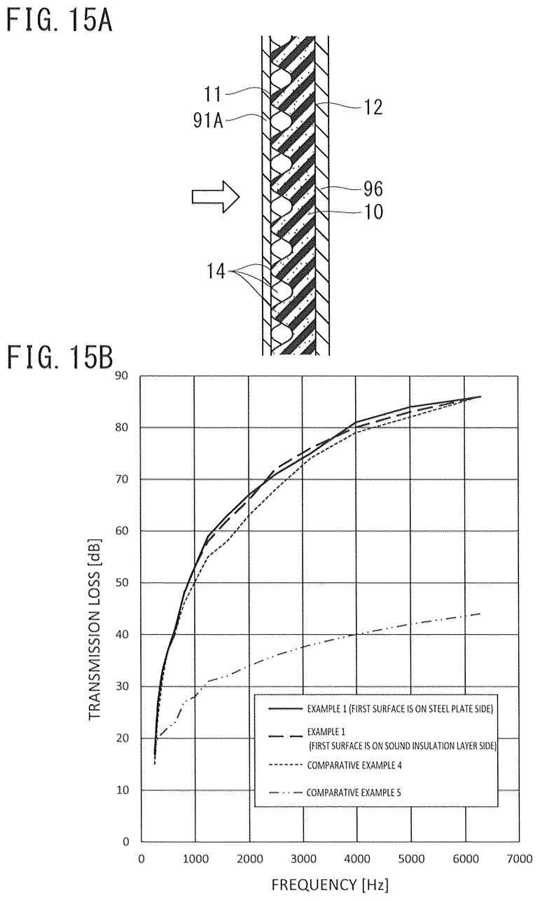

The transmission loss was measured in accordance with JIS A1441-1:2007 in Example 1 and Comparative Examples 4 and 5. As illustrated in FIG. 15A, in Example 1 and Comparative Example 4, the vibration damping member was sandwiched between the steel plate 91A (thickness: 0.8 mm) and a sound insulation layer 96, and sound was incident from the steel plate 91A side. As the sound insulation layer 96, a plate material (basis weight: 3600 g/m²) of polyvinyl butyral (PVB) was used. In Example 1, the measurement was performed in an example in which the first surface 11 of the vibration damping member 10 was directed toward the steel plate 91A and an example in which the first surface 11 was directed toward the sound insulation layer 96. In Comparative Example 5, the measurement is performed using only the steel plate 91A. The plane sizes of the vibration damping member, the steel plate 91A, and the sound insulation layer 96 are 500 mm×500 mm.

### (6) Tensile Strength, Elongation

The tensile strength and elongation of each vibration damping member were measured in accordance with JIS K6400-5.

### <Evaluation Results>

As illustrated in FIG. 12B, it has been found that Example 1 having the plurality of protrusions 14 on the first surface 11 can reduce stress with respect to the same strain as compared with Comparative Example 4 having the flat first surface 11. In particular, in the strain range of 0 to 30%, it is possible to significantly reduce stress with respect to the same strain. For example, the range (proportional limit) in which the stress increases linearly with respect to the strain is up to a strain of about 3% (0.03) in Comparative Example 4, whereas the range (proportional limit) is a strain of 30% (0.3) or more in Example 1.

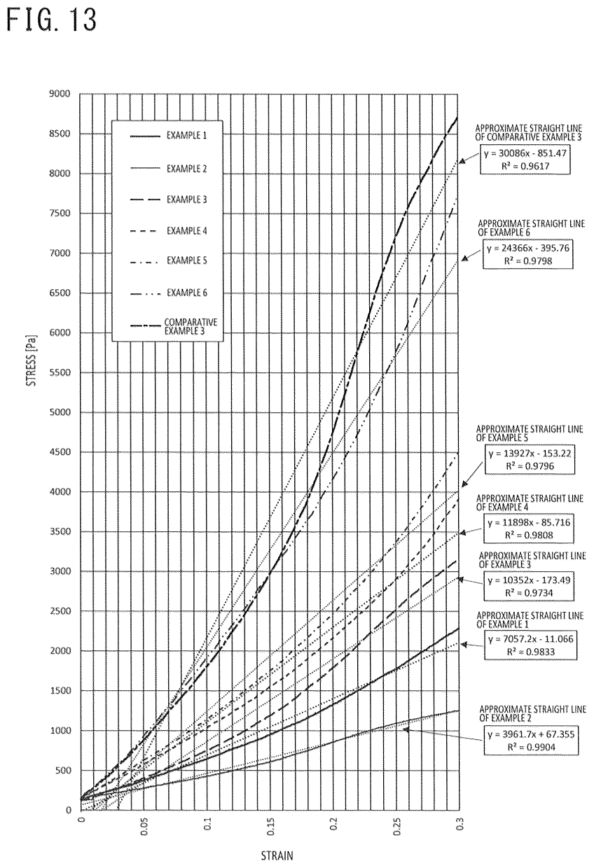

As illustrated in FIG. 12A, in Examples 1 to 6, it has been confirmed that the vibration damping property is significantly improved (the vibration damping property is evaluated as “o”) as compared with Comparative Examples 1 and 2 in which the vibration damping member is formed of a nonwoven fabric and blank Comparative Example 5 with no vibration damping member. In addition, for the vibration damping member formed of a polyurethane resin foam, it has been confirmed that the vibration damping members of Examples 1 to 6 can exhibit an excellent vibration damping property as compared with the vibration damping member of Comparative Example 3. Here, in the vibration damping members of Examples 1 to 6, the average elastic modulus in the compressive strain range of 0 to 30% is lower than that of the vibration damping member of Comparative Example 3 (the vibration damping property is evaluated as “x”), but the above average elastic modulus is higher than those of the vibration damping members of Comparative Examples 1 and 2 (the vibration damping property is evaluated as “x”). Specifically, as illustrated in FIGS. 12A and 13, the above average elastic modulus (the slope of the approximate straight line) of the vibration damping member is from 3 kPa to 27 kPa, inclusive, in Examples 1 to 6, but exceeds 27 kPa in Comparative Example 3, and is lower than 3 kPa in Comparative Examples 1 and 2. In Examples 1 to 6, the compressive strain corresponding to the proportional limit is 30% (0.3) or more in the stress-strain curve (see, for example, FIG. 12B). In addition to Example 1 and the like in which the pitch between the top portions of the protrusions 41 of the first surface 11 was 31 mm, another Example in which the pitch was 16 mm was also tested, and the average elastic modulus was calculated. As a result, it has been confirmed that there is almost no difference in the average elastic modulus due to the difference in pitch.

As described above, it has been confirmed that Examples 1 to 6 in which the foam is used and the average elastic modulus at a compressive strain of 0 to 30% is from 3 kPa to 27 kPa, inclusive, can exhibit a particularly excellent vibration damping property. In addition, in the vibration damping members of Examples 1 to 6, the apparent density is 40 kg/m³ or less, which is particularly preferable from the viewpoint of weight reduction. Here, in general, it is considered that the vibration damping property tends to be higher in a vibration damping member having a high apparent density. However, it can be understood that, for example, the vibration damping member of Example 6 exhibits a particularly excellent vibration damping property even as compared with the vibration damping member of Comparative Example 3 having an equivalent or higher apparent density. As described above, with the vibration damping member having an average elastic modulus from 3 kPa to 27 kPa, inclusive, an excellent effect, which cannot be predicted from the conventional technical level, has been confirmed in which the vibration damping property is particularly improved even as compared with the vibration damping member having an equivalent or higher apparent density.

In addition, as illustrated in FIG. 15B, it has been confirmed that the vibration damping member 10 of Example 1 including the profiled surface can increase the transmission loss as compared with blank Comparative Example 5 and the vibration damping member of Comparative Example 4 with no profiled surface. In particular, the transmission loss is increased by 4 to 5 dB at a maximum at 1000 Hz to 3150 Hz that greatly contribute to the clarity of conversation (audibility of speech) in the vehicle interior. It has been confirmed that a good result can be obtained regardless of the orientation of the profiled surface (first surface) in Example 1,

### <Supplementary Note>

Hereinafter, a feature group extracted from the above-described embodiments and examples will be described while showing effects and the like, as necessary. In the following, for easy understanding, corresponding components in the above embodiments will be appropriately indicated in parentheses or the like, but this feature group is not limited to the specific components indicated in the parentheses or the like.

For example, the following feature group relates to a vibration damping member, and can be considered to be acquired with the object: “a need exists for a novel vibration damping technique” with regard to the background art: “various techniques for suppressing vibration have been proposed (for example, JP H10-203267 A (paragraph [0010], etc.)).”

### [Feature 1]

A vibration damping member including: a foam having a first outer surface (11) on which a plurality of protrusions are arranged and having a foam in which an average elastic modulus in a compressive strain range of 0 to 30% being from 3 kPa to 27 kPa, inclusive.

With the vibration damping member of this feature, it is possible to improve the vibration damping property. In addition, for example, in a case where the vibration damping member is sandwiched between members, the first outer surface on which the plurality of protrusions are formed is brought into contact with at least one of the members, which makes it possible to inhibit the resilient force of the foam from becoming too strong, and to inhibit the vibration damping member from becoming difficult to be fixed.

### [Feature 2]

The vibration damping member according to feature 1, wherein the first outer surface is a profiled surface.

According to this feature, the uneven pattern on the first outer surface can be easily formed. Moreover, the first outer surfaces of a pair of vibration damping members can be formed at a time.

### [Feature 3]

The vibration damping member according to feature 1 or 2, having an apparent density of 40 kg/m³ or less.

According to this feature, the vibration damping member can be reduced in weight. For example, in a case where the vibration damping member is mounted on a vehicle, it is possible to improve the fuel efficiency and electricity efficiency of the vehicle.

### [Feature 4]

The vibration damping member according to any one of features 1 to 3, wherein the plurality of protrusions are two-dimensionally arranged on the first outer surface.

### [Feature 5]

The vibration damping member according to any one of features 1 to 4, wherein the plurality of protrusions are disposed so that the protrusions are repeated in a given pattern on the first outer surface.

### [Feature 6]

The vibration damping member according to any one of features 1 to 5, wherein the protrusions have a shape in which a cross-sectional area decreases toward a protruding tip.

### [Feature 7]

A roof liner for a vehicle including the vibration damping member according to any one of features 1 to 6 on an upper surface, wherein the first outer surface is directed upward.

According to this feature, the roof liner can be provided with a function to reduce the vibration of a roof panel. In addition, according to this feature, the vibration damping member is mounted to a vehicle simply by mounting the roof liner to the vehicle, which makes it possible to easily mount the vibration damping member.

### [Feature 8]

A vehicle structure, wherein the vibration damping member according to any one of features 1 to 6 is sandwiched between a vehicle body panel and an interior member, and the first outer surface is brought into contact with at least one of the vehicle body panel or the interior member.

### [Feature 9]

A ceiling structure of a vehicle, wherein the vibration damping member according to any one of features 1 to 6 is sandwiched between a roof liner and a roof panel, and the first outer surface is brought into contact with at least one of the roof liner or the roof panel.

According to this feature, it is possible to reduce the vibration of the roof panel.

### [Feature 10]

A vibration damping structure, wherein the vibration damping member according to any one of features 1 to 6 is sandwiched between members, and the first outer surface is brought into contact with at least one of the members.

### [Feature 11]

A vibration damping structure including:
the vibration damping member according to any one of features 1 to 6; and
a member with which the first outer surface of the vibration damping member is brought into contact.

According to the features 10 and 11, it is possible to damp the vibration of the member with which the vibration damping member is brought into contact.

Although specific examples of the technique included in the claims are disclosed in the present specification and the drawings, the technique described in the claims is not limited to these specific examples, and includes those obtained by variously modifying and changing the specific examples, and also includes those obtained by singly extracting a part from the specific examples.

### DESCRIPTION OF THE REFERENCE NUMERAL

10 Vibration damping member
11 First surface
14 Protrusion
20 Roof liner
90 Vehicle
91 Roof panel
100 Ceiling structure

1-7. (canceled)

8. A vibration damping member comprising a foam having a first outer surface on which a plurality of protrusions are arranged and having an average elastic modulus in a compressive strain range of 0 to 30% being from 3 kPa to 27 kPa, inclusive.

9. The vibration damping member according to claim 8, wherein the first outer surface is a profiled surface.

10. The vibration damping member according to claim 8, having an apparent density of 40 kg/m³ or less.

11. The vibration damping member according to claim 9, having an apparent density of 40 kg/m³ or less.

12. A roof liner for a vehicle comprising the vibration damping member according to claim 8 on an upper surface, wherein the first outer surface is directed upward.

13. A roof liner for a vehicle comprising the vibration damping member according to claim 9 on an upper surface, wherein the first outer surface is directed upward.

14. A vehicle structure, wherein the vibration damping member according to claim 8 is sandwiched between a vehicle body panel and an interior member, and the first outer surface is brought into contact with at least one of the vehicle body panel or the interior member.

15. A vehicle structure, wherein the vibration damping member according to claim 9 is sandwiched between a vehicle body panel and an interior member, and the first outer surface is brought into contact with at least one of the vehicle body panel or the interior member.

16. A ceiling structure of a vehicle, wherein the vibration damping member according to claim 8 is sandwiched between a roof liner and a roof panel, and the first outer surface is brought into contact with at least one of the roof liner or the roof panel.

17. A ceiling structure of a vehicle, wherein the vibration damping member according to claim 9 is sandwiched between a roof liner and a roof panel, and the first outer surface is brought into contact with at least one of the roof liner or the roof panel.

18. A vibration damping structure, wherein the vibration damping member according to claim 8 is sandwiched between members, and the first outer surface is brought into contact with at least one of the members.

19. A vibration damping structure, wherein the vibration damping member according to claim 9 is sandwiched between members, and the first outer surface is brought into contact with at least one of the members.
